(19) United States
(12) Patent Application Publication
(10) Pub. No.: US 2005/0253306 A1
(43) Pub. Date: Nov. 17, 2005

(54) Stopper made of foamed, thermoplastic synthetic material

(76) Inventor: Gerhard Piriwe, Oberwaltersdorf (AT)

Correspondence Address: MERCHANT & GOULD PC, P.O. BOX 2903, MINNEAPOLIS, MN, 55402-0903, US

(21) Appl. No.: 10/521,969

(22) PCT Filed: Jul. 2, 2003
(86) PCT No.: PCT/AT03/00185

§ 371 Date: Mar. 7, 2005

(30) Foreign Application Priority Data
Jul. 17, 2002 (AT) A 1079/2002

(51) Int. Cl. H05B 6/00

(52) U.S. Cl. 264/482

(57) ABSTRACT

The invention refers to a method for the production of a plug from foamed thermoplastic with a cork brand, by means of a laser beam. The invention is characterized in that the focus point of the used laser beam lies in a plane different from the surface of the plug. The basic idea is that to avoid damage to the thin plastic film, the energy needed for the color change of the pigments is applied, in low density for such a purpose, over a large period of time.

The invention refers to a method for the production of a plug made of foamed thermoplastic, which is provided with a cork brand.

Such a plug is known from European Patent No. 1,022,226 A from the applicant.

It should be pointed out first that, on the one hand, the designation “plug” was selected so as to avoid misunderstandings regarding the material from which the plug or stopper is made, but that, on the other hand, the designation “cork brand” was retained, which is frequently common, particularly, with stoppers of wine bottles made of cork. Especially in the high-quality wine sector, corks with a cork brand are almost exclusively used. The reasons why plugs made of plastic have been increasingly used for some time include, on the one hand, the increasing difficulty in obtaining cork in the necessary quality, in sufficient quantity, and at reasonable prices; on the other hand, there is the wish to use plugs with exactly defined qualities which always remain constant even with large numbers of units. Moreover, however, it is also desirable to provide even plugs made of plastic with a cork brand, for different reasons—which are mainly, although not exclusively, of a psychological nature.

For the plug itself, polyethylene can be taken into consideration, almost exclusively, because of food-technical and commercial considerations; the production of the cork brand is attained similar to the original cork brand, with a plug made of cork by the heat effect, wherein, however, the coloring cannot be attained by a partial charring of the cork material, but rather only by the coloring of inorganic, food-compatible pigments, which change their color with the effect of heat. In actual practice, Iriodin® thereby has been accepted as a pigment; this refers to pearly luster pigments based on mica and titanium oxide or iron(III) oxide, although this material is not mentioned explicitly in European Patent No. 1,022,226 A, indicated above.

The heating of the plug takes place with a laser, since the use of the burning iron normally used with plugs made of cork has turned out not to be feasible. There is always, namely, the breaking down of the foamed material, so that the plugs are, on the one hand, optically unattractive and, on the other hand, are impaired with respect to their density effect.

As an additional state of the art, one can refer to European Patent No. 0,754,562 A—which has to do with the inscription of mold plates, films, and the like, made of polyolefins, using a laser, and which discloses mica pigments, explicitly the one under the name Iriodin®, as pigments that can change colors under the effect of heat.

From WO 94/25513 A, a method is known for producing plugs, in particular, for wine bottles, from various styrene containing copolymers, whose jacket surfaces can be imprinted, after a preparation of the surface by the action of electromagnetic radiation has taken place. Without such a preparation, the pigments to be applied during printing on the far too smooth surface are not applied permanently.

It has been shown that the plugs according to the first-mentioned type do not fulfill the demands made on them satisfactorily, but that their production is connected with a series of problems, which could not be solved satisfactorily up to now. These problems have to do with the effects of the laser on the foamed plastic, which behaves in a manner completely different from the same plastic in a densely cast mold. In particular, there is a roughening of the surface due to the destruction of the topmost (outermost) layer, leading to sealing problems and, at least, leading to an optically unattractive appearance, which is not desired particularly when used to cork wine bottles, and in many cases such cannot be accepted.

In other cases, there is an insufficient recoloring of the pigments, so that the cork brand obtained is optically unattractive, full of holes, streaky, or not recognizable at all. These errors too lead to the formed plugs having to be considered as rejects.

Thus, there is a need for a method for the production of a cork brand on a plug made of foamed thermoplastic, preferably polyethylene, by which plugs with a cork brand are created in a reliable manner and with a high reproducibility, which have satisfactory characteristics both with respect to functionality and their appearance. It should be possible to carry out these results on plugs in a reliably reproducible manner and with few rejects.

In accordance with the invention, these goals are attained in that the used laser beam is not focussed on the surface of the plug, but rather is used defocussed, wherein a larger surface is struck with a lower energy density than with a focussed beam. According to a development of the invention, the focus point is in a plane, seen in the direction of the laser beam, before the surface of the plug. This lower density permits the use of a laser with a lower wobble frequency than is common with the focussed operation wherein, considered integrated over time, at least approximately the same energy supply is again received at each site of the laser action, all total, as with the usual focussed use of the laser with a high wobble frequency, but with the difference that the sensitive skin of the foam bubbles of the foamed plastic, which do not have a noteworthy heat capacity are not overheated in isolated points and melted. Nevertheless, it is ensured that the pigments, whose color change takes place only with a specific energy supply or temperature elevation, receive a supply of the needed energy or reach the needed temperature and are reliably colored.

In particular, the following method parameters have proved good, which can be applied, with a knowledge of the invention, on other units and other compositions of the plug with the aid of a few simple trials:

The method in accordance with the invention was used, as is described in the following, with a plug made of polyethylene (which can be obtained form the Borealis Company), which is mixed with a dye, propellant, and the colorable pigment (laser patch) (all from the Gabriel Chemie Company). This is injected in an injection molding machine, then injected into the mold after gradual heating to 185° C. (fluctuation ±3° C.). The injected quantity, actually mass, depends on the desired plug volume, particularly on the desired plug length; values of 8.5 g are common for medium-long plugs. The cooling of the walls of the mold is important, since with a cooling water temperature of approximately 12° C., an “outer skin” of the plug is formed, in which the density of the plug is 5 to 10 times as high as in its interior.

This formation of an outside area, with different characteristics from those in the core of the plug, below referred to as “outer skin,” is essential both for the sealing characteristics of the plug and also for its optical appearance, but this is already known from the state of the art and is mastered by the specialist in the area of the injection molding of foamed plastics, in particular, foamed polyethylene.

The cooling time of the plug depends on the type and quantity of the propellant gas used; it is essential that after the ejection from the mold, a subsequent propelling of the product no longer occurs, since, in that way, the dimensions and the quality of the outer skin would be impaired.

A plug produced in such a manner is then lasered with a lamp-pumped 30-watt YAG laser with a 254-mm objective, which focusses the laser beam at an object distance of 410 mm. The speed is set at 700 to 900 mm/s. This speed is the superposition of the wobble movement and the forward movement. At a pulse length of 0.01 ms, with a QS frequency (frequency, as to how often the beam is turned on or off per minute) between 2800 and 3500 min⁻¹ and a lamp current between 25 and 30 amperes, not the 410 mm to the focus point, but rather 420 mm, was maintained as the distance between the surfaces of the plugs, and the wobble frequency was maintained at 200 to 500 Hertz.

Line widths between 0.1 and 0.5 mm were lasered (broad lines can be attained without any problems) and the cork brand thus obtained was formed, on the one hand, optically in a satisfactory manner and, on the other hand, without impairment of the smooth surface.

In a comparative experiment, the plug was used at a focal distance of 410 mm and the wobble frequency was varied between 200 and 600 Hertz. Depending on the wobble frequency, the cork brand obtained exhibited a rough to melted surface, or it was nonusable because of insufficient coloring of the pigment.

In another experiment in accordance with the invention, in which no attention was paid to the formation of an outer skin, but in which plugs were produced, which are used by many who, subscribe to another view regarding the function and mode of action of plugs, material like that described in the above experiment was extruded to form a continuous rod, cooled in a water bath, and cut to the desired length. With this material, it was also possible to attain a satisfactory cork brand, without impairment of the surface, with the laser of the aforementioned type, allowing a power reduction from 30 watts to 22 to 25 watts and an increase in the wobble frequency to 400 to 550 Hertz.

In another experiment in accordance with the invention, a continuous rod made of polyethylene, surrounded with a polymer film (in the experiment, polyethylene, but polyurethane can also be possible; food compatibility and the adaptation to the application area of the plug is necessary), wherein the pigment Iriodin was contained only in this film area along the jacket. For the creation of a satisfactory cork brand with this plug, the energy of the laser was reduced to 15 watts and the wobble frequency was reduced to 280 Hertz.

The invention is not limited to the explained examples, but rather can be modified in different ways. These modifications refer both to the composition of the plug and to the mode of its production, on the one hand, and the laser devices used, on the other hand. It is essential that, in accordance with the knowledge, that the foamed plastic, with respect to radiation with a laser or light, either visible or invisible, behaves differently from the same plastic in an unfoamed, cast state and that therefore, in accordance with the invention, the laser is used defocussed—that is, that the surface to be lasered is found before, or preferably behind, the point on which the laser beam is regarded as focused. In order to balance out the thus attained reduction of the specific energy (relative to the lasered surface) and to supply the pigments with sufficient energy for the color change, the wobble frequency is correspondingly reduced, so that in the end, approximately the same energy as has been usual before, but in a “more gentle” form is supplied.

With the knowledge of the invention and the embodiment examples, it is easy for the specialist in the area of the production of plugs from foamed plastic material, and the creation of a cork brand on such grafts, to find the parameters favorable for this application purpose with another composition of the plug and the finish with another laser, by means of a few simple experiments.

The basic idea of the invention is that to avoid damage to the thin plastic skin, the energy necessary for the color change of the pigments is applied in low density for such a purpose, over a greater period of time. Thus, with a knowledge of the invention, it is easy for the specialist in the area of laser technology, at least in consultation with a specialist for thermoplastics and thermally colorable pigments, to determine the parameters favorable for a particular application.

1. Method for the production of a cork brand on a plug made of foamed thermoplastic, in which by means of a laser beam, thermally recolorable pigments are recolored, characterized in that the focus point of the laser beam used lies in a plane different from the surface of the plug.

2. Method according to claim 1, characterized in that the focus point is in a plane, seen in the direction of the laser beam, before the surface of the plug.

3. Method according to claim 1 or 2, characterized in that the wobble frequency is smaller than the wobble frequency for the same, but “unfoamed” plastic.

4. Method according to claim 3, characterized in that the energy supplied to a given area of the cork brand, over the time of the lasering, integrated with the laser, essentially corresponds to the energy supplied to the same plastic in unfoamed form.
